(19) United States
(12) Patent Application Publication
(10) Pub. No.: US 2014/0088801 A1
(43) Pub. Date: Mar. 27, 2014

(54) SYSTEM AND METHOD FOR TESTING TRAIN BRAKES

(71) Applicant: PROGRESS RAIL SERVICES CORPORATION, Albertville, AL (US)

(72) Inventor: MARK JOSEPH BARTONEK, Blue Springs, MO (US)

(73) Assignee: PROGRESS RAIL SERVICES CORPORATION, Albertville, AL (US)

(21) Appl. No.: 13/628,260

(22) Filed: Sep. 27, 2012

(51) Int. Cl. B60T 17/18; G06F 11/30; G01M 17/08

(52) U.S. Cl. 701/19; 701/34.4; 701/33.9; 701/32.3; 701/32.4

(57) ABSTRACT

The present disclosure is directed to a method of monitoring the performance of a wheel brake for a wheel on a train car. The method may include detecting a first temperature of the wheel with the wheel brake deactivated. The method may also include activating the wheel brake and detecting a second temperature of the wheel with the wheel brake activated. The method may include determining a wheel brake condition based on at least the first and second temperatures of the wheel.

### TECHNICAL FIELD

The present disclosure relates generally to a test system and method and, more particularly, a system and method for testing train brakes.

### BACKGROUND

Monitoring systems for the railroad industry provide methods and apparatus for automatic determination of the conditions of wheels and bearings on passing trains. One apparatus for automatically detecting potential defects is described in U.S. Pat. No. 8,160,832. Different types of data are gathered from detectors or sensors that each provide new information about system defects, and the data are combined in an effort to reduce the rate of false indications.

Existing monitoring systems look for abnormally hot wheels or bearings—using “hot wheel” detectors or “hot box” detectors. In the case of U.S. Pat. No. 8,160,832, the system monitors data from various orthogonally related sensors, and combines the resulting independent data to reduce the rate of false indications. None of the existing systems provide a means for testing whether brakes are properly activating and deactivating from an operational perspective, rather than as a cause of a potentially serious problem once an actual “hot wheel” or “hot box” has been detected.

The system and method of the present disclosure solves one or more problems set forth above and/or other problems in the art.

### SUMMARY

In one aspect, the present disclosure is directed to a method of testing the performance of a wheel brake for a wheel on a train car. The method may include detecting a first temperature of the wheel in a testing area with the wheel brake deactivated. The method may also include activating the wheel brake, and detecting a second temperature of the wheel with the wheel brake activated. The method may further include determining a wheel brake condition based on the first and second temperatures of the wheel.

In another aspect of the disclosure, a system is provided for testing a wheel brake on a train car moving along a train track. The system may include a plurality of temperature sensors, each configured to detect a temperature of a wheel on the train car. The system may also include a processor configured to receive a first signal from a first one of the plurality of temperature sensors indicative of a first temperature of the wheel with the wheel brake deactivated. The processor may also be configured to receive a second signal from a second one of the plurality of temperature sensors indicative of a second temperature of the wheel after activating the wheel brake. The processor may be configured to determine a wheel brake condition based on the first and second signals.

### BRIEF DESCRIPTION OF THE DRAWINGS

FIG. 1 is a diagrammatic illustration of an exemplary disclosed train;

FIG. 2 is a schematic illustration of an exemplary disclosed brake monitoring system that may be used with the train of FIG. 1; and

FIG. 3 is a flowchart depicting an exemplary disclosed method that may be performed by the system of FIG. 2.

### DETAILED DESCRIPTION

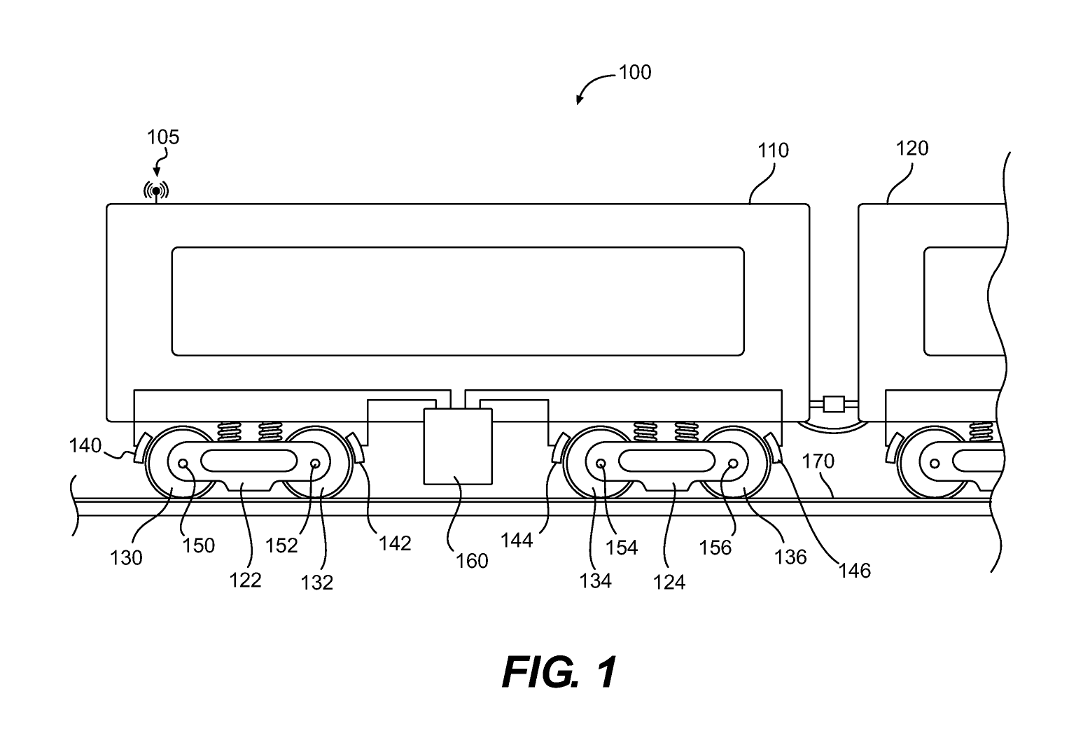

FIG. 1 illustrates a portion of a train 100 including one or more cars 110, 120. Each car, such as shown for car 110, may include a plurality of trucks, such as trucks 122 and 124. A car may have as many as ten or more trucks, although more typically the number of trucks is two per car. Each truck may include two or more axle bearing systems (“axles”), such as axles 150 and 152 on truck 122, and axles 154 and 156 on truck 124.

In addition, train 100 may include a pneumatic braking system, which may include a main air line from the locomotive (not shown), from which pressurized air is supplied to various brake valves, such as brake valve 160 shown in FIG. 1. Brake valve 160 may control the operation of one or more brake cylinders (not shown), which may control the actuation of one or more brake shoes 140, 142, 144, 146. Each brake shoe includes friction material configured for contact against respective wheels 130, 132, 134, 136. One of ordinary skill in the art will recognize that other alternative brake systems may include disc brake systems, hydraulic fluid braking systems, etc.

In various implementations, each truck 122, 124 with two or more axles 150, 152, 154, 156 per truck 122, 124 and two wheels 130, 132, 134, 136 per axle 150, 152, 154, 156 may be associated with a single brake valve 160. Wheels 130, 132, 134, 136 are shown at one end of respective axles 150, 152, 154, 156, and may be paired with matching wheels (not shown) at the opposite ends of their respective axles. In alternative implementations, each brake valve 160 may be associated with more than one truck 122, 124. Braking systems associated with each brake valve may operate, (and may fail) independently of one another. Therefore, various implementations may monitor wheel temperatures, as discussed in detail below, for wheels that are connected to the same brake valve together. Furthermore, the following discussions of individual wheels, associated individual wheel brakes, etc., will be understood by one of ordinary skill in the art to also apply to groupings of wheels, such as all of the wheels on a single truck, or all of the wheels on a pair of trucks connected with the same brake valve, etc.

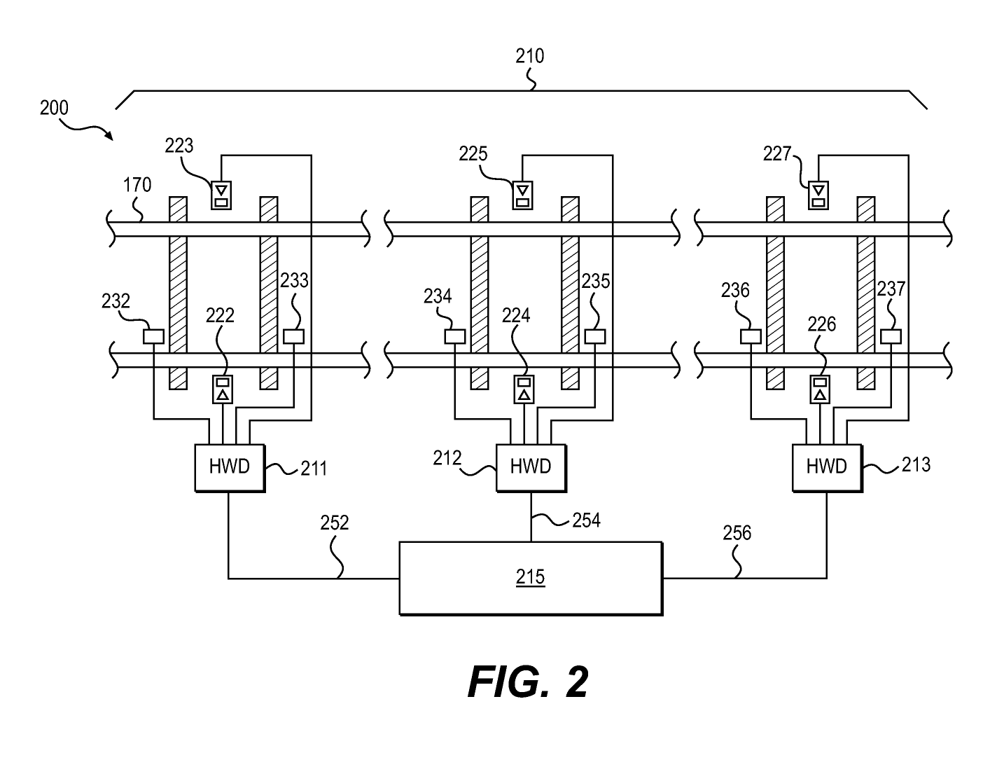

FIG. 2 illustrates an example implementation of the disclosure directed to a testing system 200 for testing brake valve 160 and associated braking components including brake shoes 140, 142, 144, and 146, on train cars 110, 120 (shown in FIG. 1) moving along a train track 170.

Wayside “hot wheel” detectors (HWD) 211, 212, and 213 may be positioned along train track 170 to automatically sense the temperature of wheels of a passing train, and alarm when the wheel temperatures become too great for continued safe operation. HWD 211, 212, and 213 may include temperature sensors 222, 223, 224, 225, 226, and 227, which are configured to convert sensed infrared heat energy produced by a component such as a passing train wheel to an electrical signal that is proportional to the amount of heat output by the wheel relative to ambient temperature. One of ordinary skill in the art will recognize that there are a variety of other temperature sensing technologies also suitable for use with various implementations of the disclosure.

As shown in FIG. 2, at least a first wheel temperature sensor 222, and a second wheel temperature sensor 223, may be disposed on opposite sides of train track 170 in order to be able to detect the temperatures of the wheels on both sides of a passing train car. Temperature sensors 224 and 225 associated with HWD 212, may be positioned on opposite sides of train track 170 at a predetermined spaced interval along train track 170 from HWD 211. Optional additional pairs of wheel temperature sensors associated with additional hot wheel detectors, such as wheel temperature sensors 226 and 227 associated with HWD 213, may also be disposed at predetermined spaced intervals further along train track 170.

The spaced pairs of wheel temperature sensors are included in a predesignated testing area 210 along the train track 170. Multiple testing areas similar to testing area 210 may be spaced along train track 170, with each testing area including two or more spaced pairs of wheel temperature sensors. The testing areas may be located along stretches of train track over varying terrains. Downhill stretches of train track may provide testing areas where braking of the train cars is performed under natural circumstances, and therefore does not require performing a special braking operation for testing the brakes when braking would not normally be performed.

The pairs of wheel temperature sensors 222 and 223, 224 and 225, and 226 and 227 placed along opposite sides of train track 170 may produce signals indicative of the temperatures for each wheel on a per axle basis, and may provide those signals to associated HWD 211, 212, and 213, respectively. Each HWD 211, 212, and 213 may also include associated wheel position sensors 232 and 233, 234 and 235, and 236 and 237, respectively.

As a train car wheel passes each HWD 211, 212, and 213, the associated pairs of wheel position sensors may provide signals to the associated HWD, which the HWD may use in defining a window when signals from the associated wheel temperature sensors are received by the HWD and converted into temperatures of the passing wheel. Each of the HWD 211, 212, and 213 may be positioned at wayside stations along train track 170, and may be communicatively coupled with a processor 215 of testing system 200. Processor 215 may be located remotely from train track 170, in a dispatch office, on board the train, or in one or more wayside stations. HWD 211 may communicate signal 252 to processor 215, HWD 212 may communicate signal 254 to processor 215, and HWD 213 may communicate signal 256 to processor 215. One of ordinary skill in the art will recognize that signals 252, 254, and 256 may be communicated to processor 215 through a wireless connection, over cellular in the form of a voice communication, over an ethernet connection, over a network, or through other means.

The processor 215 may also be configured to only activate temperature sensors 222, 223, 224, 225, 226, and 227 of HWD 211, 212, and 213 when associated wheel position sensors 232, 233, 234, 235, 236, and 237 indicate the presence of a wheel within the window between each pair of wheel position sensors. One of ordinary skill in the art will recognize that various implementations may include wheel position sensors 232, 233, 234, 235, 236, and 237 comprising physical proximity transducers positioned adjacent train track 170, as shown in FIG. 2. In alternative implementations, the position of a wheel on a train car may be determined by other wheel position locators including devices that analyze a global positioning system (GPS) signal associated with a position of the train car. These wheel position locators may be located on the train 100, alongside the track 170, in wayside station houses, or in other remote locations. A GPS receiver 105 (shown in FIG. 1) may be located on a train car 110, 120 to provide wheel position location capabilities, identify where the train car is within testing area 210 at any time relative to the HWDs, etc.

One of ordinary skill in the art will recognize that although processor 215 is illustrated as a single unit, the functionality provided by processor 215 could be provided instead by one or more processors. The one or more processors may be part of a server, client, network infrastructure, mobile computing platform, or a stationary computing platform, one or more of which may be contained in a dispatch office, on the train, in a single wayside housing, multiple wayside housings, or at remote locations communicatively coupled over wired or wireless networks.

### INDUSTRIAL APPLICABILITY

The disclosed method and system may allow for testing the performance of a wheel brake on a train car by detecting a first reference temperature of a wheel with the wheel brake deactivated, and then activating the brake for a period of time or distance along the train track. A second, elevated temperature of the wheel may then be detected with the brake activated. A processor may be configured to determine a wheel brake condition by comparing the difference between the first and second wheel temperatures with a threshold. The processor may also be configured to perform other functions such as gathering data regarding the conditions of the wheel brakes on all wheels for each train car, and identifying patterns for each train car. Data gathered and processed by the processor may be used to identify when certain control actions should be taken, such as stopping the train to perform maintenance, scheduling future maintenance, performing autonomous control, etc.

Aspects of the present disclosure provide the functionality of detecting an improperly operating train brake through the recognition that a change in wheel temperature can be observed in conjunction with partial activation and deactivation of the wheel brake. A properly braking wheel may dissipate heat generated by the friction material in the brake shoe coming into contact with the wheel. In alternative braking systems such as hydraulic fluid braking systems, heat may also be dissipated as the rolling kinetic energy of the train wheels is transferred to the braking system through friction, effectively converting the kinetic energy into thermal energy. Hot wheel detectors include temperature sensors that are capable of detecting the temperatures of train wheels passing the temperature sensors. Rather than waiting for the temperature of the wheel to get above a predetermined threshold, at which continued operation of the train could be unsafe, aspects of the present disclosure contemplate using the temperature sensors to detect changes in temperature of a wheel from when the wheel brake is deactivated, to when the wheel brake has been activated.

In various implementations, the temperatures of one or more of the wheels on a truck may be averaged together or otherwise processed in arriving at a value that may be used in performing the comparisons of wheel temperatures with brakes activated and wheel temperatures with the brakes deactivated, as discussed in more detail below. Each temperature sensor may also be configured to sample a plurality of overlapping areas on any particular wheel that is passing. These “snapshots” of the temperature of the passing wheel may also be averaged together or otherwise processed to arrive at the value used in a comparison of temperature of a wheel with an activated brake to the temperature of that wheel with the brake deactivated.

In various implementations of the present disclosure, processor 215 may be configured to receive the temperatures, and compare the temperatures detected by different ones of the temperature sensors. In one example implementation, processor 215 is configured to compare temperatures of passing wheels with deactivated brakes as detected by temperature sensors 222 and 223 of HWD 211, with temperatures of the same wheels with activated brakes as detected later by temperature sensors 224 and 225 of HWD 212.

The coordinated functionality of processor 215, temperature sensors 222, 223, 224, 225, 226, and 227, and wheel position sensors 232, 233, 234, 235, 236, and 237, enables measurement of a first, reference wheel temperature when braking is deactivated and a second, elevated wheel temperature when braking is activated. The processor may be configured to compare the difference between the two temperatures with a threshold difference value for a determination of whether the difference between the temperatures is indicative of a properly operating brake. A malfunctioning brake could be caused by improperly functioning brake valves, worn brake shoes, or other circumstances. The processor 215 may also be configured to implement a control action if the comparison of the two temperatures results in a determination that the difference between the temperatures is less than the threshold difference, which may be indicative of a malfunctioning brake. The control actions implemented by the processor 215 may include, but are not limited to, sending an alert, sounding an alarm, sending instructions to be followed manually by a train operator, performing autonomous control of the train, scheduling maintenance functions to be performed at a later time, etc. Various implementations of this disclosure provide a testing system that may allow for the automated testing of every brake on every train car on a train as a train is moving along a train track.

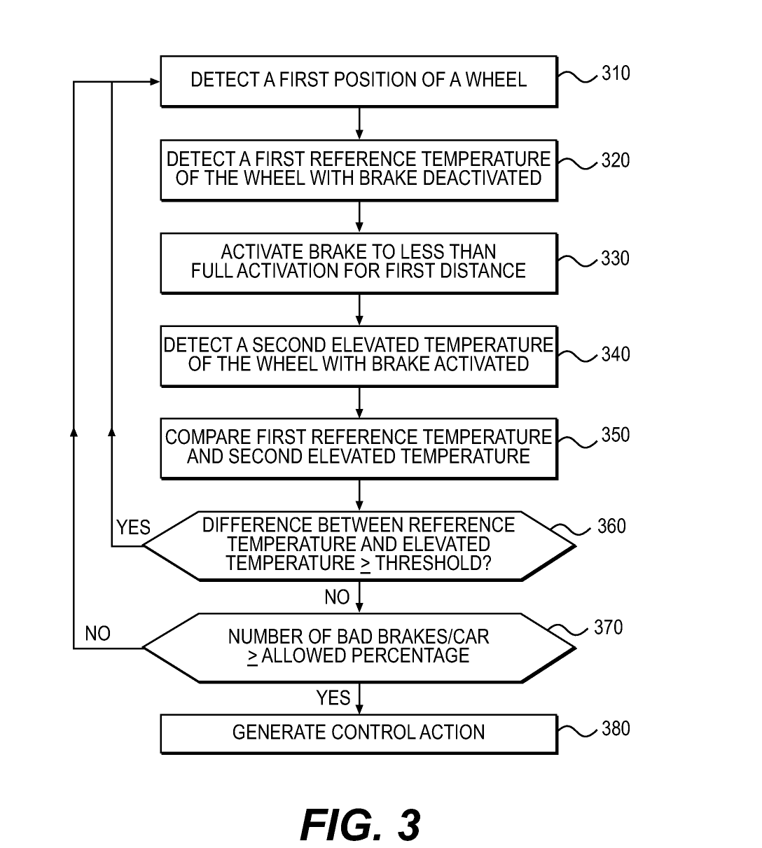

Referring to FIG. 3, in one exemplary implementation, at step 310 processor 215 may be configured to detect a first position of a wheel 130 within a designated testing area 210 as train 100 passes through the testing area 210. Processor 215 may be configured to receive a signal 252 from 211 and associated wheel position sensors 232 and 233 indicative of the presence of wheel 130 in between wheel position sensors 232 and 233.

At step 320, processor 215 may be further configured to receive a signal 252 from HWD 211 and wheel temperature sensors 222 and 223 indicative of a first reference temperature for wheel 130 (and the matching wheel on the other side of the train) with the wheel brake and brake shoe 140 deactivated. At step 330, a wheel brake with brake shoe 140 may be activated to contact wheel 130 at less than full activation, and maintained in the partial braking condition for a predetermined distance until reaching the location of HWD 212. In various exemplary implementations, the distance between HWD 211 and HWD 212 may be any distance from several hundred yards, to approximately one half mile, to one mile or more.

At step 340, processor 215 may be configured to receive a second signal 254 from HWD 212 and associated temperature sensors 224 and 225 indicative of a second, elevated temperature of the wheel 130 (and the matching wheel on the other side of the train) with the wheel brake and brake shoe 140 activated. The distance between HWD 211 and HWD 212, and between associated wheel position sensors 232, 233, 234, and 235 may be selected to provide sufficient time, based on parameters such as the speed of the train, ambient conditions, etc., for a particular wheel with partially activated brakes to heat up by an amount that enables an accurate, measurable, and repeatable comparison of the difference between the first reference temperature and the second elevated temperature of the wheel 130.

At step 350, processor 215 may be configured to compare the first reference temperature and the second, elevated temperature of the wheel 130, and at step 360, determine whether the difference between the first and second wheel temperatures is greater than or equal to a threshold amount. If the difference between the first and second temperatures is greater than or equal to the threshold amount, processor 215 may return to step 310. If the difference between the temperatures is not greater than or equal to the threshold, which may be indicative of a malfunctioning brake, at step 370 processor 215 may be further configured to compare a total number of possibly malfunctioning brakes on one train car to an allowable percentage of potentially malfunctioning brakes on that car.

At step 380, processor 215 may be configured to implement one of the control actions described above if the number of potentially malfunctioning brakes is greater than or equal to the allowable percentage. In variations to these procedures, processor 215 may be configured to deactivate the brake 140 (or any other brake and brake shoe on any other wheel or combination of wheels) and receive a signal 256 from another set of temperature sensors 226 and 227 at HWD 213 indicative of the temperature of the wheels again with brakes deactivated when the train our 110 is still within the testing area 210. One of ordinary skill in the art will recognize that variations to the above-described procedures may include variations in the number of times a brake is activated and deactivated within a testing area, the number of times the temperatures are measured, the spacing of the HWD's, the spacing of the wheel position sensors, variations in the times when the processor 215 receives signals from the temperature sensors indicative of the temperature of a passing wheel, and variations in the relationships between these parameters.

The amount by which a brake may be activated in order to generate a detectable difference in temperature of the wheel from when the wheel brake is deactivated, may be less than full activation of the brake, e.g., approximately 10%-20% of full activation of the brake, approximately 5%-10% of full activation, or other ranges of percentages of full activation. By only activating a brake to this set amount in the designated test areas, excessive wear on the brakes can be avoided. Testing of the brakes in this manner will also allow for early determination of a malfunctioning brake, before the situation has gotten to the point that the “hot wheel” detector is sounding an alarm. Additionally, testing of the brakes may be performed while the train is moving, and using automated readings of wheel temperatures, rather than manual, physical inspections of every brake with the train stopped.

It will be apparent to those skilled in the art that various modifications and variations can be made to the disclosed brake testing system without departing from the scope of the disclosure. Other embodiments of the brake testing system will be apparent to those skilled in the art from consideration of the specification and practice of the brake testing system disclosed herein. It is intended that the specification and examples be considered as exemplary only, with a true scope of the disclosure being indicated by the following claims and their equivalents.

### LIST OF ELEMENTS

100 Train
105 GPS receiver
110, 120 Train Car(s)
122, 124 Truck(s)
130, 132, 134, 136 Wheel(s)
140, 142, 144, 146 Brake Shoe(s)
150, 152, 154, 156 Axles
160 Brake Valve
170 Train Track
200 Testing System
210 Testing Area
211 Hot Wheel Detector
212 Hot Wheel Detector
213 Hot Wheel Detector
215 Processor
222 Wheel Temperature Sensor
223 Wheel Temperature Sensor
224 Wheel Temperature Sensor
225 Wheel Temperature Sensor
226 Wheel Temperature Sensor
227 Wheel Temperature Sensor
232 Wheel Position Sensor
233 Wheel Position Sensor
234 Wheel Position Sensor
235 Wheel Position Sensor
236 Wheel Position Sensor
237 Wheel Position Sensor
252 Signal
254 Signal
256 Signal
310 STEP: Detect a first position of a wheel
320 STEP: Detect a first reference temperature of the wheel with brake deactivated
330 STEP: Activate brake to less than full activation for first distance
340 STEP: Detect a second elevated temperature of the wheel with brake activated
350 STEP: Compare first reference temperature and second, elevated temperature
360 STEP: Determine whether difference between first and second temperatures > or = threshold
370 STEP: Determine whether the number of had brakes on a car is > or = allowed percentage
380 STEP: Generate control action

What is claimed is:

1. A method of testing the performance of a wheel brake for a wheel on a train car, the method comprising:
detecting a first temperature of the wheel in a testing area with the wheel brake deactivated;
activating the wheel brake;
detecting a second temperature of the wheel with the wheel brake activated; and
determining a wheel brake condition based on the first and second temperatures of the wheel.

2. The method of claim 1, wherein determining the wheel brake condition includes comparing a difference between the first and second temperatures of the wheel with a threshold.

3. The method of claim 1, further including detecting a position of the wheel before detecting the first temperature of the wheel.

4. The method of claim 1, wherein detecting the first temperature and detecting the second temperature is performed automatically after the wheel enters the testing area.

5. The method of claim 3, wherein detecting the position of the wheel includes analyzing a GPS (global positioning system) signal associated with a position of the train car.

6. The method of claim 1, further including deactivating the wheel brake at least an additional time when the train car is still within the testing area, and detecting a temperature of the wheel after deactivating the wheel brake.

7. The method of claim 1, wherein activating the wheel brake includes activating the wheel brake by a set amount sufficient to cause the wheel to rise in temperature by a detectable amount.

8. The method of claim 7, wherein the set amount is approximately 10%-30% of full activation of the brake.

9. A system for testing a wheel brake for a wheel on a train car moving along a train track, wherein the system comprises:
a plurality of temperature sensors, each configured to detect a temperature of the wheel on the train car; and
a processor configured to:
receive a first signal from a first one of said plurality of temperature sensors indicative of a first temperature of the wheel with the wheel brake deactivated;
receive a second signal from a second one of said plurality of temperature sensors indicative of a second temperature of the wheel after activating the wheel brake; and
determine a wheel brake condition based on the first and second signals.

10. The system of claim 9, further including at least one wheel position sensor, wherein the processor is further configured to receive a third signal from the at least one wheel position sensor and receive the first signal only when the third signal indicates the wheel of the train car entering a testing area and being located in a first position relative to the first temperature sensor.

11. The system of claim 10, wherein the at least one wheel position sensor is a GPS device or a proximity transducer.

12. The system of claim 10, wherein the processor is further configured to receive a fourth signal from a third one of said plurality of temperature sensors indicative of a third temperature of the wheel after deactivating the wheel brake.

13. The system of claim 9, wherein the second temperature sensor is positioned at a predetermined distance from said first temperature sensor sufficient to allow the wheel to heat up by an accurately measurable amount after the wheel brake has been activated.

14. The system of claim 9, wherein the processor is further configured to implement a control action if the difference between the first and second temperatures is less than a threshold.

15. The system of claim 10, wherein the processor is further configured to receive a signal from at least one of the first and second temperature sensors based on the third signal.

16. The system of claim 9, wherein the processor is further configured to receive a third signal from a third one of said plurality of temperature sensors indicative of a third temperature of the wheel after deactivating the wheel brake.

17. The system of claim 16, wherein the processor is further configured to implement a control action if the difference between the second and third temperatures of the wheel is less than a threshold.

18. The system of claim 14, wherein the processor is further configured to implement the control action only if the wheel is a first wheel of a plurality of wheels on the train car and the difference between the first and second temperatures is less than a threshold for a percentage of the plurality of wheels greater than an allowed percentage of the wheels.

19. The system of claim 9, wherein the processor is configured to receive the second signal indicative of the second temperature of the wheel after activating the wheel brake to approximately 10%-30% of full activation of the brake.

20. A method of monitoring the performance of a wheel brake for a wheel on a train car, the method comprising:
detecting a first position of the wheel on the train car that has entered a testing area along a train track;
detecting a first temperature of the wheel with the wheel brake deactivated;
activating the wheel brake;
detecting a second position of the wheel at a point a predetermined distance from the first position;
detecting a second temperature of the wheel at the second position;
comparing a difference between the first and second temperatures to a threshold; and
implementing a control action when the difference is less than the threshold.
